(19) United States
(12) Patent Application Publication
(10) Pub. No.: US 2014/0261786 A1
(43) Pub. Date: Sep. 18, 2014

(54) DRAIN SYSTEMS

(71) Applicants: Christopher Matthew Burau, Port Hueneme, CA (US); Mark Dunn Mitchell, Simi Valley, CA (US)

(72) Inventors: Christopher Matthew Burau, Port Hueneme, CA (US); Mark Dunn Mitchell, Simi Valley, CA (US)

(21) Appl. No.: 13/835,602

(22) Filed: Mar. 15, 2013

(51) Int. Cl. F16K 31/12

(52) U.S. Cl. CPC F16K 31/12
USPC 137/505

(57) ABSTRACT

A drain valve comprising: a head; and a cantilevered spring coupled at one end to the head and at an opposite end to a portion of a drain system such that when the cantilevered spring is biased to a normally closed position, the head obstructs a hole. In some embodiments, the drain valve is installed in an aircraft fire suppression system. In yet other embodiments, the cantilevered spring has a variable radius serpentine cross section.

The present patent document relates to drain systems. More particularly, the present patent document relates to condensate drain systems for use in aircraft fire suppression systems.

### BACKGROUND

Lots of various different kinds of systems involve discharging a fluid or gas or some combination thereof through piping. The piping in such systems is usually designed to transfer the fluid/gas from a storage container to a delivery location. When such systems have requirements to operate under conditions below the freezing point of undesirable liquid or vapor phase contaminates or other potential fluids that may enter the system, such as water condensate, it is often important to have a drain in the piping system to allow any excess fluid to drain off. The drain allows the excess fluid to drain from the system and prevents the excess fluid from freezing in the pipes and eventually blocking or cracking the pipes. Excess fluid may come from many sources including fluids used for equipment maintenance, deicing or condensation to name a few.

One example of a system that is designed to be able to transfer fluid under extreme temperature conditions is a fire suppression system on an aircraft. A fire suppression system on an aircraft typically includes a storage container where the fire suppressing agent is stored in a compressed liquid form. When the system is activated, the fire suppressing agent is rapidly discharged from the storage container and travels through a distribution piping to the scene of the fire or potential fire. Depending on the fire suppression agent used, the fire suppressing agent preferably stays in a gas or liquid or gas/liquid form as it travels from the storage container through the discharge piping.

Aircraft fire suppression systems, like many fluid piping systems, are subject to a wide range of temperatures. These temperature may range from +105° C. when the aircraft is on the tarmac on a hot day, to as low as −55° C. when the aircraft is at high altitudes. Because of the requirement to be operable under such a wide range of temperatures, and particularly at such low temperatures, aircraft fire suppression systems preferably include a condensate drain. As already mentioned, the drain prevents excess fluid and/or condensation from remaining in the system and freezing to cause clogs and/or a malfunction in the system when the temperature drops below the freezing point of water or other fluid that may have entered the system.

Currently, fire suppression systems that require the drainage of excess fluids often just cut a hole in the piping to allow the excess fluids to drain out. One problem with this design is that during discharge, the drain hole allows considerable amounts of fire suppression fluid to leak out during bottle discharge and be wasted. Loss of this fire suppression fluid results in decreased concentration of the fire suppression fluid or agent in the fire zone. Because the contents of the discharge piping are under pressure, a significant amount of suppression agent may be lost through the drain hole when the system is activated. In tests performed by the patentee, as much as 12% to 15% of the discharge agent was being lost through the drain hole of a conventional fire suppression system when the fire suppression system was activated. Loss of material reduces the efficiency of the system because it reduces the amount of discharge agent that gets delivered to the fire zone. Because weight is a critical constraint in the design of any aircraft system, wasting suppression agent is extremely undesirable.

### SUMMARY OF THE EMBODIMENTS

In view of the foregoing, an object according to one aspect of the present patent document is to provide a drain valve. Another aspect of the present patent document is to provide a drain system for an aircraft fire suppression system. Preferably the methods and apparatuses address, or at least ameliorate one or more of the problems described above. To this end, a drain valve is provided. In one embodiment, the drain valve comprises: a head; and a cantilevered spring coupled at one end to the head and at an opposite end to a portion of a drain system such that when the cantilevered spring is biased to a normally closed position, the head obstructs a drain hole, and when the cantilevered spring is unbiased the head is in a normally open position in which the head is spaced apart from the drain hole.

In some embodiments, the drain valve is installed in an aircraft fire suppression system. However in other embodiments, the drain valve may be installed in any type of system that delivers a pressurized gas or liquid through piping. In some embodiments, the drain valve is installed at the bottom of a Y-junction.

The head is preferably shaped to mate with the perimeter of the drain hole when the cantilevered spring is in the normally closed position. For example, in some embodiments, the head includes a convex portion designed to mate with the circumference of a circular drain hole. In yet other embodiments, the head may be conically shaped. Regardless of the specific shape of the head employed, the head is preferably designed to seal the drain hole when the cantilevered spring is in the normally closed position.

In a preferred embodiment, the cantilevered spring has a variable radius serpentine cross section. In an even more preferred embodiment the variable radius serpentine cross section is designed to prevent a single pivot point when the cantilevered spring is flexed. In embodiments that include a cantilevered spring, the cantilevered spring is designed to hold the head away from a top of the hole when there is no pressure differential between a bottom of the hole and the top of the hole, in other words, when the cantilevered spring is unbiased. In some embodiments that include a cantilevered spring, the cantilevered spring is designed to position the head to obstruct a top of the hole when a sufficient pressure differential occurs between the top of the hole and a bottom of the hole, for example, when the pressurized fluid is discharged through the distribution system including the drain valve. In the case of a fire suppression system, this would occur when the fire suppression agent is discharged from the bottle through the distribution system.

In a preferred system the drain valve is formed from a single piece of material. The material is preferably metal but in some implementations may be made from other materials like plastic. [Is ceramic a real possibility here?] In other embodiments, the drain valve may be made from multiple pieces that are coupled together.

In another aspect of the present patent document, a method for closing a drain valve is provided. In a preferred embodiment, the method is used to close a drain valve in an aircraft fire suppression system. The method comprises, coupling a drain valve proximate to the drain hole wherein the drain valve is designed to cover the drain hole. Closing the drain valve with the initial velocity of the discharge agent. Holding the drain valve closed with the pressure differential caused across the drain hole when the fire suppression system is activated.

As described more fully below, the apparatus and methods of the embodiments of a drain valve are provided. Further aspects, objects, desirable features, and advantages of the apparatus and methods disclosed herein will be better understood from the detailed description and drawings that follow in which various embodiments are illustrated by way of example. It is to be expressly understood, however, that the drawings are for the purpose of illustration only and are not intended as a definition of the limits of the claimed invention.

### BRIEF DESCRIPTION OF THE DRAWINGS

FIG. 1 illustrates a perspective view of an embodiment of a drain system.

FIG. 2 illustrates a top down view of one embodiment of a drain valve.

FIG. 3 illustrates one embodiment of a drain valve installed in the bottom of a Y-junction pipe included in a pressurized distribution system, such as a fire suppression discharge system.

### DETAILED DESCRIPTION OF THE EMBODIMENTS

The embodiments disclosed in the present patent document are related to drain valves. More particularly, the embodiments disclosed herein relate to drain valves for use in pressurized liquid/gas distribution systems. Even more particularly, the embodiments disclosed herein relate to drain valves for use in an aircraft fire suppression system.

FIG. 1 illustrates a cross section of one embodiment of a drain system 10. As seen in FIG. 3, drain system 10 is included in a pressurized distribution system 22. The embodiment shown in FIG. 1 includes a drain hole 12 and a drain valve 11. In some embodiments, the drain valve 11 may be referred to as a valve 11 or a cover 11. In the embodiment shown in FIG. 1, the drain valve 11 includes a head 14 and a cantilevered spring 16. The cantilevered spring 16 connects the head 14 to the drain system 10. Accordingly, one end of the cantilevered spring 16 is connected to the head 14 while the opposite end of the cantilevered spring 16 is connected to the drain system 10.

In the illustration of FIG. 1, the drain system is shown in an open configuration. In this configuration the head 14 is held in a position away from the hole 12 such that fluid can exit through the drain hole 12. In the open configuration, the cantilevered spring is in an unbiased or substantially unbiased position. In this position, the cantilevered spring 16 is essentially unflexed other than any flex that may be caused by the weight of the head 14 and the weight of the cantilevered spring 14 itself. When the drain system transitions to a closed position, the head 14 is lowered over the hole 12 such that it obstructs the hole 12. In such a condition, the cantilevered spring 15 becomes flexed to a normally closed position.

In a preferred embodiment, the drain valve 11 may be made from one continuous piece. However, in other embodiments, the drain valve 11 may be made from two or more pieces. In one embodiment, the head 14 is made from one piece and the cantilevered spring 16 is made from another piece. The drain valve 11 may be made from any type of metal, plastic, rubber or any other material applicable to the final implementation. In a preferred embodiment, the drain valve 11 is made from Inconel 625. In embodiments where the head 12 and cantilevered spring 16 are made from more than one piece, they may be made from different materials. In embodiments where they are separately manufactured pieces, they may be coupled together by welding, bonding, brazing, gluing, riveting, with fasteners or any other method suitable for the materials selected for the separate pieces.

The cantilevered spring 16, may be formed in any shape or size and should be designed to provide an appropriate spring constant. The spring constant may be designed based on the anticipated velocity of the fluid in the distribution system 22 and the pressure differential that will occur between the top of the hole 12A and the bottom of the hole 12B when the distribution system 22 is in operation. The cantilevered spring 16 is designed to place the head 14 in a position to obstruct the hole 12 from the flow of the gas/liquid when the distribution system 22 is activated yet hold the head 14 sufficiently away from the hole 12 to allow excess fluid to drain through the hole 12 when the distribution system 22 is not activated. As one skilled in the art will recognize, different spring constants may be applicable for different distribution systems.

The continuous vibration from the aircraft, or other vehicle or platform, in which the drain valve 11 may be mounted may eventually cause material fatigue. In a preferred system, the cantilevered spring 16 has a variable radius serpentine cross section. The variable radius serpentine cross section of the cantilevered spring 16 prevents the cantilevered spring 16 from pivoting about a single point but rather allows flexing along the length of the cantilevered spring 16. This has the desired result of allowing the material to share strain displacements and thus helps reduce the likelihood of material fatigue. The unique variable geometry also prevents the device from developing fatigue generating resonances when experiencing high vibration levels when the cantilevered mechanism is in the normally open position and the aircraft or other vehicle or platform in which the drain system 10 is mounted is in use.

In a preferred embodiment, the variable radius serpentine cross section of the cantilevered spring is constructed from a plurality of curved sections 18A, 18B and 18C. In an even more preferred embodiment, the cantilevered spring 16 is made from a plurality of curved sections with varying radiuses. In an even more preferable embodiment, the varying radiuses get smaller as the cantilevered spring 16 approaches the head 14 of the drain valve 11. In one embodiment, the cantilevered spring 16 includes three (3) curved sections 18A, 18B and 18C. In other embodiments the cantilevered spring 16 may have between two (2) and ten (10) curved sections. In yet other embodiments, the cantilevered spring 16 may have more than ten (10) curved sections.

In some embodiments, the radius of the largest curved section 18A may be twice as big as the radius of the smallest curved section 18C. In yet other embodiments, the variation in the radius of the curved sections may be between 30% and 100%. In still yet other embodiments, the variation in the radius of the curved sections may be between 75% and 100%. In other embodiments, the radiuses of the curved sections may vary by even more.

The head 14 of the drain valve 11 may be made of any shape or size as long as it obstructs the hole 12 when flexed into the appropriate position. For example, the head 14 may be configured to mate with the perimeter 15 of the drain hole 12. In a preferred embodiment, the head 14 almost completely obstructs the hole 12 and in an even more preferred embodiment, the head 14 completely closes the hole. In the most preferred embodiment, the head 14 may seal the hole 12.

In the embodiment shown in FIG. 1, the head 14 has a concave surface that is designed to mate with the circumferential perimeter 15 of the top of the hole 12A such that the hole 12 is obstructed when the drain valve 11 is flexed into the closed position by the cantilevered spring 16. In other embodiments, the head 14 may have a conical shape or any of numerous other suitable designs to obstruct hole 12. In a preferred embodiment, the drain valve 11 may further include a seal such as an o-ring to help seal the interface between the hole 12 and the drain valve 11. In various embodiments that include a seal, the seal may be coupled to the drain valve 11 or the hole 12. However, a seal is not required.

In a preferred embodiment, the head 14 and cantilevered spring 16 are designed to prevent resonance of the assembly. In a preferred embodiment, the head 14 is designed to be light in weight so that resonance is reduced. In a preferred embodiment, the cantilevered spring 16 has a variable radius serpentine cross section, which helps eliminate resonance. A light weight head 14 and properly designed cantilevered spring 16 reduces fluttering movement and unwanted movements during when the drain valve 11 is in the open position.

In some embodiments, the drain valve 11 comprises a formed single cantilever mechanism that includes a convex sealing geometry at one end as shown in FIG. 1. In operation, the convex sealing geometry located at the cantilever beam end is deflected by a fluid velocity to close and cover the drain hole 12. The device is activated by exposure to fluid velocity during bottle discharge and remains closed as the fluid passes over the device and over the drain hole 10 due to the pressure differential across the convex geometry at the outlet of the drain feature. When local velocity and pressure differential decrease to a level less that the force generated by the spring constant of the cantilevered mechanism, the device re-opens restoring the mechanism to the normal function permitting any collected moisture inside the discharge piping network to escape.

FIG. 2 illustrates a top down view of one embodiment of a drain valve 11. In the embodiment shown in FIG. 2, the drain valve comprises a head 14, and a cantilevered spring 16. As seen from FIG. 1, the head 14 includes a convex portion 13 that projects towards hole 12, but from the top view shown in FIG. 2 the convexed portion 13 forms a concave cup-shaped region 17. In some embodiments, the convex portion 13 may be referred to as a dimple 13. Dimple 13 is the curved portion of the head 14 that is designed to mate with the hole 12. In a preferred embodiment, the dimple 13 may be formed in the head 14 simply be pressing the material to form a dent or dimple 13 on the bottom side of drain valve 11 and a concave cup-shaped region 17 on the top side. In other embodiments, more complicated manufacturing methods may be used include constructing the dimple out of a separate piece and coupling the dimple 13 to the head 14. In some embodiments, including a concave cup-shaped region 17 on the top side of drain valve 14 may facilitate the closing of the valve when the distribution system in which it is mounted is in use.

FIG. 3 illustrates one embodiment of a drain valve 11 installed in the bottom of a Y-junction pipe 20. In a preferred embodiment, the drain valve 11 is installed in the lowest portion of a distribution pipe system 22, such as a fire suppression discharge system. Installing the drain valve 11 in the lowest portion of the distribution pipe system 22 allows any residue liquid in the pipe system to eventually drain out of the hole 12 when the drain valve is in the open position. In some embodiments, the drain valve 11 is installed in the bottom of a Y-junction pipe 20 in a fire suppression system. The Y-junction pipe 20 is the location where the gas/fluid leaving the bottle branches out into multiple pipes. In a preferred embodiment, the drain valve 11 is installed at the bottom of a Y-junction pipe in an aircraft fire suppression system.

In some embodiments of the present patent documents, the drain valve prevents less than 3% of the discharge agent to exit out of the drain valve during discharge. In an even more preferable embodiment, the drain valve prevents less than 2% of the discharge agent to exit out of the drain valve during discharge. In an even more preferable embodiment, the drain valve prevents less than 1% of the discharge agent to exit out of the drain valve during discharge

Although the embodiments have been described with reference to preferred configurations and specific examples, it will readily be appreciated by those skilled in the art that many modifications and adaptations of the electronic device with a customizable image and methods therefore described herein are possible without departure from the spirit and scope of the embodiments as claimed hereinafter. Thus, it is to be clearly understood that this description is made only by way of example and not as a limitation on the scope of the embodiments as claimed below.

What is claimed is:

1. A drain valve comprising:
a head; and
a cantilevered spring coupled at one end to the head and at an opposite end to a portion of a drain system such that when the cantilevered is biased to a normally closed position, the head obstructs a drain hole, and when the cantilevered spring is unbiased the head is in a normally open position in which the head is spaced apart from the drain hole.

2. The drain valve of claim 1, wherein the drain valve is installed in an aircraft fire suppression system.

3. The drain valve of claim 1, wherein the drain hole is circular and the head includes a convex portion designed to mate with the circumference of the drain hole.

4. The drain valve of claim 3, wherein the head is designed to seal the hole when the cantilevered spring is in the normally closed position.

5. The drain valve of claim 1, wherein the cantilevered spring has a variable radius serpentine cross section.

6. The drain valve of claim 5, wherein the variable radius serpentine cross section is designed to prevent a single pivot point when the cantilevered spring is flexed.

7. The drain valve of claim 2, wherein the drain system is installed at the bottom of a Y-junction.

8. The drain valve of claim 1, wherein the cantilevered spring is designed to hold the head away from a top of the hole when there is no pressure differential between a bottom of the hole and the top of the hole.

9. The drain valve of claim 1, wherein the cantilevered spring is designed to position the head to obstruct a top of the hole when a pressure differential occurs between the top of the hole and a bottom of the hole.

10. The drain valve of claim 1, wherein the drain valve is formed from a single piece of material.

11. An aircraft fire suppression drain system comprising:
a drain hole; and
a drain valve comprising:
a head; and
a cantilevered spring coupled at one end to the head and at an opposite end to a portion of the drain system such that the head obstructs the hole when the cantilevered spring is biased to a normally closed position, and when the cantilevered spring is unbiased the head is in a normally open position in which the head is spaced apart from the drain hole.

12. The drain system of claim 11, wherein the drain system is installed in an aircraft fire suppression system.

13. The drain system of claim 11, wherein the drain hole is circular and the head includes a convex portion designed to mate with the circumference of the hole.

14. The drain system of claim 13, wherein the head is designed to seal the hole when the cantilevered spring is in the normally closed position.

15. The drain system of claim 11, wherein the cantilevered spring has a variable radius serpentine cross section.

16. The drain valve of claim 15, wherein the variable radius serpentine cross section is designed to prevent a single pivot point when the cantilevered spring is flexed.

17. The drain system of claim 11, wherein the drain valve is formed from a single piece of material.
